(19) United States
(12) Patent Application Publication
(10) Pub. No.: US 2014/0010245 A1
(43) Pub. Date: Jan. 9, 2014

(54) LIGHT SOURCE FOR AIMING, TARGET ACQUISITION, COMMUNICATION AND TRACKING

(71) Applicants: Jonathan Kiva Flaster, San Diego, CA (US); Adam Daniel Flaster, San Diego, CA (US)

(72) Inventors: Jonathan Kiva Flaster, San Diego, CA (US); Adam Daniel Flaster, San Diego, CA (US)

(21) Appl. No.: 13/924,454

(22) Filed: Jun. 21, 2013

Related U.S. Application Data
(63) Continuation-in-part of application No. 13/209,303, filed on Aug. 12, 2011.
(60) Provisional application No. 61/410,554, filed on Nov. 5, 2010.
(60) Provisional application No. 61/373,085, filed on Aug. 12, 2010.

(51) Int. Cl. H01S 3/101

(52) U.S. Cl. CPC H01S 3/101
USPC 372/5; 372/29.015

(57) ABSTRACT

A light generation and emission system and method is disclosed. A light generator generates light from a diode at a wavelength between 300 nm and 490 nm. A light beam forming subsystem forms the light to a directional light beam, and a controller that controls and directs the directional light beam to a target. The light generator can be suitably used for aiming, target acquisition, communication, identification, scanning, surveying, tracking, ignition and weapons operation.

### CROSS REFERENCE TO RELATED APPLICATIONS

This application is a continuation-in-part of U.S. patent application Ser. No. 13/209,303, filed Aug. 12, 2011, titled: “Light Source for Aiming, Target Acquisition, Communication and Tracking;” which in turn claims priority from U.S. Provisional Application No. 61/410,554, filed on Nov. 5, 2010 and U.S. Provisional Application No. 61/373,085, filed on Aug. 12, 2010, each of which are incorporated herein in its entirety.

### BACKGROUND

Laser Diodes (LDs) and Light Emitting Diodes (LEDs) currently exist in the red, green, and infrared wavelength ranges, and have been used for target acquisition and communications for some time. Most of these colors are very bright and visible by the human eye, which has both positive and negative aspects, as well as being more visible between the source and target. The infrared range cannot be readily detected by the human eye, but requires special equipment to be used.

However, the near UV spectrum is near the end of the visible color spectrum and has not been used with LDs or LEDs due to visibility and power limitations. The UV range also has the unique properties of the beam being harder to see while also fluorescing the target. This can allow for enhanced covertness, safety, and utility of operation for users of the devices. Diodes (LDs or LEDs) in the UV or near-UV range have historically been too costly to produce or too difficult to control their power. However, what is needed is an LD or LED device for aiming, target acquisition, communication, identification, scanning, surveying, and tracking that is cost-effective and practical with regards to power consumption and producibility.

### SUMMARY

This document presents a near-UV or equivalent light source having a wavelength between a range of 300 nm to 490 nm, and in some implementations between 10 nm and 490 nm, and implemented as either a Laser Diode (LD) or Light Emitting Diode (LED). The light source also includes power regulation circuitry, controller software and a batter monitor. The light source and a system employing the light source can optionally use control circuitry and modulation, using digital or analog logic, and software to alter behavior and functionality as well as interfaces for activation and communications. The light source replaces existing devices for aiming, target acquisition, communication, identification, scanning, surveying, tracking, ignition and weapons operation.

In one aspect, a method is disclosed. The method includes the steps of generating light from a diode, the light being generated at a wavelength between 300 nm to 490 nm. The method further includes forming the light to a directional light beam, and controlling to the directional light beam to direct the directional light beam at a target. The target can be a moving target, a combustion chamber, a weapons trigger, or any other type of target.

In another aspect, a system includes a light generator that generates light from a diode at a wavelength between 10 nm and 490 nm, a light beam forming subsystem that forms the light to a directional light beam, and a controller that controls and directs the directional light beam to a target.

In yet another aspect, a light emission system includes a housing having at least one outlet aperture. The housing contains a diode that emits light at a wavelength between 10 nm and 490 nm, a power regulator that provides power to the diode at a specific power level, a controller responsive to input signals for controlling the power regulator to generate the power at the specific power level, and optics for forming and directing the light from the diode into a directional light beam that is output through the outlet aperture.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 is a block diagram of a light emission system.

FIG. 2 is a functional block diagram of a light emission system in accordance with an alternative implementation.

FIG. 3 is a functional block diagram of a light emission system in accordance with yet another alternative implementation.

FIG. 4 is a functional block diagram of a light emission and targeting system with feedback sensor.

FIG. 5 is a functional block diagram of a light emission system for weapons operation in accordance with an alternative implementation.

FIG. 6 is a functional block diagram of a light emission system for an ignition system in accordance with an alternative implementation.

FIG. 7 is a functional block diagram of a light emission system for communications, tracking, guidance and signaling, in accordance with an alternative implementation.

FIG. 8 is a block diagram of a light emission system in accordance with another alternative implementation.

FIG. 9 is a functional block diagram of a light emission system in accordance with yet another alternative implementation.

FIG. 10 is a functional block diagram of a light emission system for communications and tracking in accordance with an alternative implementation.

FIG. 11 is a block diagram of a light emission system for landscape enhancement in accordance with an alternative implementation.

FIG. 12 is a functional block diagram of a blackout system.

FIG. 13 is a functional block diagram of a light emission system for weapons operation in accordance with an alternative implementation.

FIG. 14 is a functional block diagram of a light emission system for an ignition system in accordance with yet another alternative implementation.

Like reference symbols in the various drawings indicate like elements.

### DETAILED DESCRIPTION

This document describes a near-UV or equivalent light source having a wavelength between a range of 10 nm to 490 nm, and implemented as either a Laser Diode (LD) or Light Emitting Diode (LED). The light source also includes power regulation circuitry. The design can optionally use control circuitry and modulation, using digital or analog logic, and software to alter behavior and functionality as well as interfaces for activation and communications.

The light emitter described herein replaces existing devices for aiming, target acquisition, communication, identification, scanning, surveying, and tracking. The light emitter described herein improves on existing devices through the use of a Near-UV or equivalent Laser Diode or LED in the 10 nm to 490 nm range, which benefits due to the qualities of light in the near UV, blue, and violet spectrum in terms of low visibility of beam, power usage, increased luminance for a target, end point, or subject of interest.

A laser diode or light emitting diode is used to create a beam in the range of 10 to 490 nanometers (Blue, Violet and Near UV) to illuminate a target. A LED or LD that uses light in the 10-490 nm range has the benefits of low visibility of beam, power usage, increased luminance for an object, for applications such as aiming, target acquisition, communication, identification, scanning, surveying, and tracking.

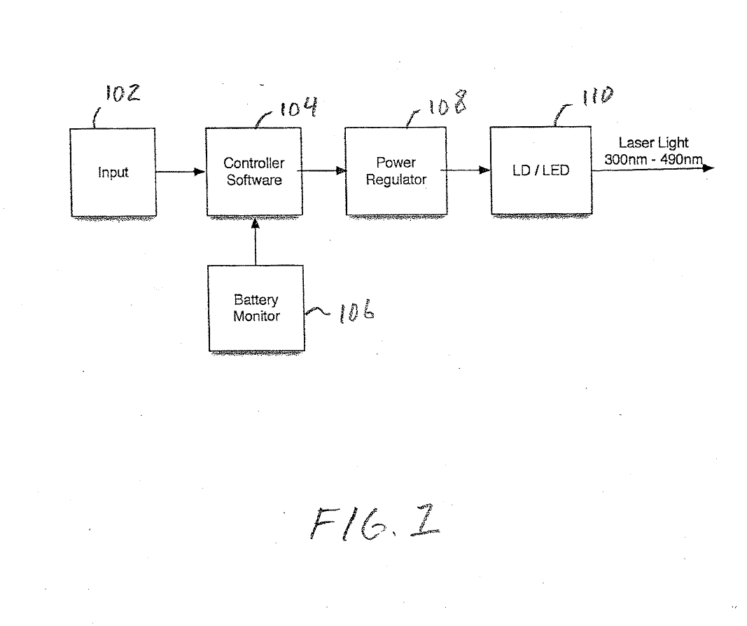

FIG. 1 is a block diagram of a light emission system 100. The light emission system 100 includes an input 102 that provides input signals to a controller 104, which is preferably implemented at least in part in software. The input signals can be from buttons, switches, dials, a keyboard, optical sensors, or other third party systems, computers, or controllers. The controller 104 also receives input from a power monitor 106, which monitors the power supply (battery or from other sources) and provides input into the controller on the status of the power source. In particular, the power monitor 106 notifies the controller module 104 when the power source is low, i.e. when a battery is almost dead.

The light emission system 100 further includes a power regulator 108, which includes discrete components and/or dedicated integrated circuits to control the voltage and current going to the LED/LD. The power regulator 108 maintains the proper power to the LD/LED over a range of voltages, raising or lowering the input voltage to ensure proper efficient power output. In some implementations, the power regulator 108 sets a maximum power level for the LD/LED, and optionally receives input from a controller mechanism which tells it when to power the LD/LED on or off. Preferably, the power regulator 108 can be modulated to obtain different relative power levels, provide different effects and turn on/off the LD. In alternative implementations, the power regulator 108 can have additional mechanisms for lowering and/or raising maximum power to adjust for environmental conditions.

The controller 104 outputs a signal to control the power regulator 108. The controller 104 can be implemented using embedded micro controllers, computers, specialized application specific integrated circuit (ASIC), complex programmable logic device (CPLD), field programmable gate array (FPGA), or other discrete analog or digital components. Input provided to the controller 104 turns on power, activates the unit, selects modes, and sets the power level. The controller 104 can optionally take input from the power monitor 106 and modulate the beam to indicate the battery level is low. This can optionally go to a separate visual, audible, or mechanical indicator to notify the power state. The controller 104 preferably controls the power level outputted by the LD/LED through pulse width modulation. Battery low indictor is current indicated through the periodic lowering/raising of the power level on the laser light, could also be done through blinking.

The light emission system includes a light emitter 110. The light emitter 110 is preferably a laser diode having a wavelength centered on the near-UV 405 nm range, but may have a wavelength of between 300 to 490 nm. In some implementations, a diode is used that is rated between 20-600 mW, and where the desired power output is achieved with a combination of current and pulse width modulation (PWM) control from the power regulator 108.

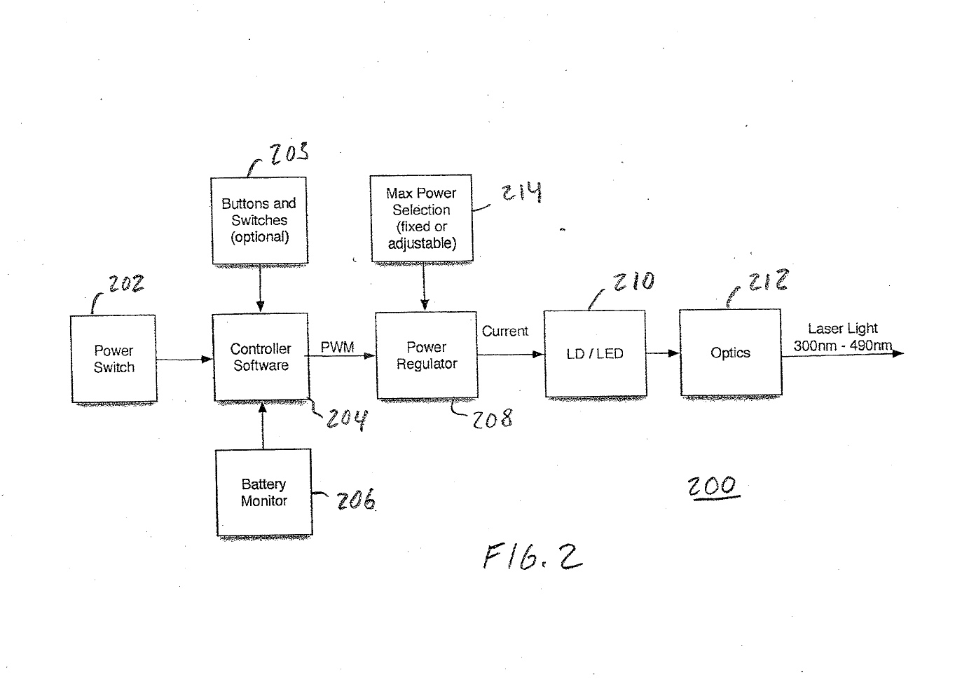

FIG. 2 is a functional block diagram of a light emission system 200 in accordance with an alternative implementation. Similar to the light emission system 100 shown in FIG. 1, light emission system 200 includes a power switch 202 and input switches/buttons 203 that provide other input signals. The light emission system 200 further includes a controller 204 that also receives input from a power monitor 206, which monitors the power supply (battery or from other sources) and provides input into the controller on the status of the power source. In particular, the power monitor 206 notifies the controller module 204 when the power source is low, i.e. when a battery is almost dead.

The light emission system 200 further includes a power regulator 208, which, as substantially described above, includes discrete components and/or dedicated integrated circuits to control the voltage and current going to the LED/LD. The power regulator 208 maintains the proper power to the LD/LED over a range of voltages, raising or lowering the input voltage to ensure proper efficient power output. In some implementations, the power regulator 208 sets a maximum power level for the LD/LED, and optionally receives input from a controller mechanism that can determine when to power the LD/LED on or off. Preferably, the power regulator 208 can be modulated to obtain different relative power levels, provide different effects and turn on/off the LD. In alternative implementations, the power regulator 208 can have additional mechanisms for lowering and/or raising maximum power to adjust for environmental conditions.

The controller 204 outputs a signal to control the power regulator 208. The controller 204 can be implemented using embedded micro controllers, computers, specialized application specific integrated circuit (ASIC), complex programmable logic device (CPLD), field programmable gate array (FPGA), or other discrete analog or digital components. Input provided to the controller 204 from the power switch 202 turns on power and activates the unit. Input from input buttons/switches 203 can be used to select modes, and set the power level. The controller 204 can optionally take input from the power monitor 206 and modulate the light beam to indicate the battery level is low. This can optionally go to a separate visual, audible, or mechanical indicator to notify the power state. The controller 204 preferably controls the power level outputted by the LD/LED through pulse width modulation. Battery low indictor is current indicated through the periodic lowering/raising of the power level on the laser light, could also be done through blinking.

The light emission system includes a light emitter 210. The light emitter 210 is preferably a laser diode having a wavelength centered on the near-UV 405 nm range, but may have a wavelength of between 300 to 490 nm. In some implementations, a diode is used that is rated between 20-600 mW, and where the desired power output is achieved with a combination of current and pulse width modulation (PWM) control from the power regulator 208. The light emission system 200 further includes optics 212. The optics 212 include one or more glass or acrylic lenses, at least one of which can include an optional antireflective coating to maximize optical transfer and culminating of the lens. This lens can be focused to a point or collimated. The focusing process can be done automatically (i.e. electro-mechanically) or manually, or be fixed at manufacturing.

The light emission system 200 further includes a maximum power selector 214 implemented as passive or active electronics that alters the settings for the power regulator setting maximum power/current that can be sent to the LED/LD. The maximum power selector 214 can optionally be controlled through another mechanism manually or automatically which can adjust for distance, ambient light, temperature, or other environmental conditions.

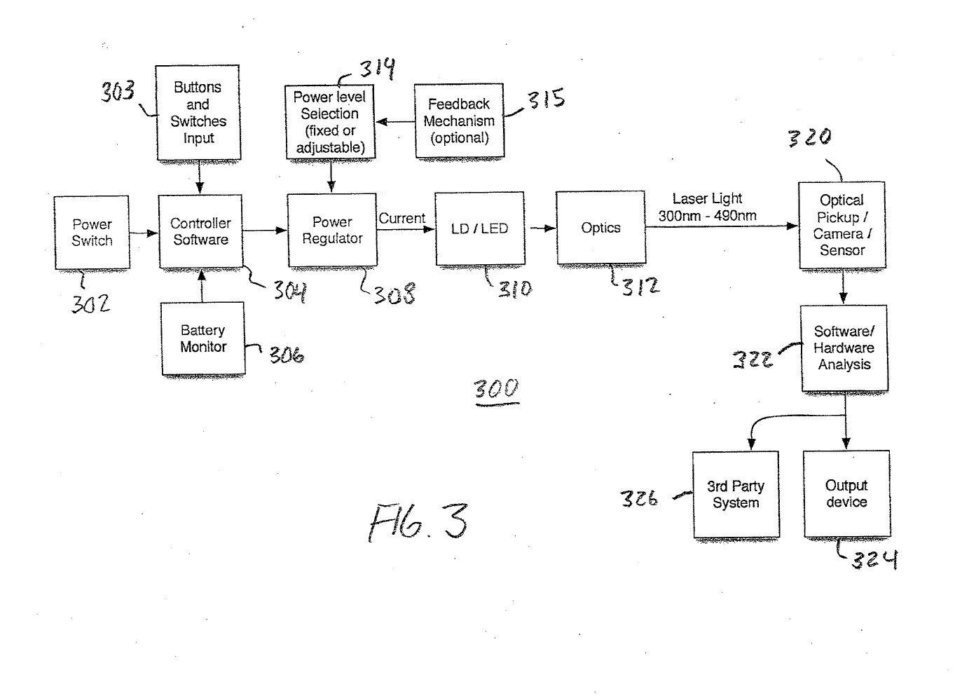

FIG. 3 is a functional block diagram of a light emission system 300 in accordance with yet another alternative implementation. Similar to the light emission system 100 shown in FIGS. 1 and 2, light emission system 300 includes a power switch 302 and input switches/buttons 303 that provide other input signals. The light emission system 300 further includes a controller 304 that also receives input from a power monitor 306, which monitors the power supply (battery or from other sources) and provides input into the controller on the status of the power source. In particular, the power monitor 306 notifies the controller module 304 when the power source is low, i.e. when a battery is almost dead.

The light emission system 300 further includes a power regulator 308, which, as substantially described above, includes discrete components and/or dedicated integrated circuits to control the voltage and current going to the LED/LD. The power regulator 308 maintains the proper power to the LD/LED over a range of voltages, raising or lowering the input voltage to ensure proper efficient power output. A power selector 314 sets the power level of the power regulator 308, and can be implemented as passive or active electronics that alters the settings for the power regulator setting maximum power/current that can be sent to the LED/LD. The maximum power selector 314 can optionally be controlled through another mechanism manually or automatically which can adjust for distance, ambient light, temperature, or other environmental conditions. The power selector 314 can be controlled or influenced by feedback mechanism 315. The feedback mechanism 315 is configured to implement a power correction method created either by a manually or automatically through optical sensors that adjust power level for position telemetry for communication or alteration in target trajectory.

The controller 304 outputs a signal to control the power regulator 308. The controller 304 can be implemented using embedded micro controllers, computers, specialized application specific integrated circuit (ASIC), complex programmable logic device (CPLD), field programmable gate array (FPGA), or other discrete analog or digital components. Input provided to the controller 304 from the power switch 302 turns on power and activates the unit. Input from input buttons/switches 303 can be used to select modes, and set the power level. The controller 304 can optionally take input from the power monitor 306 and modulate the light beam to indicate the battery level is low. This can optionally go to a separate visual, audible, or mechanical indicator to notify the power state. The controller 304 preferably controls the power level outputted by the LD/LED through pulse width modulation. Battery low indictor is current indicated through the periodic lowering/raising of the power level on the laser light, could also be done through blinking.

The light emission system 300 includes a light emitter 310. The light emitter 310 is preferably a laser diode having a wavelength centered on the near-UV 405 nm range. In some implementations, a diode is used that is rated between 20-600 mW, and where the desired power output is achieved with a combination of current and pulse width modulation (PWM) control from the power regulator 308. The light emission system 300 further includes optics 312. The optics 312 include one or more glass or acrylic lenses, at least one of which can include an optional antireflective coating to maximize optical transfer and culminating of the lens. This lens can be focused to a point or collimated. The focusing process can be done automatically (i.e. electro-mechanically) or manually, or be fixed at manufacturing.

The light emission system 300 further includes optical sensor 320. The optical sensor 320 can be any type of electronic optical pickup, camera or sensor, and is implemented as a receiving device as either a photo or optical sensor that can sense LD/LED transmission or light emission for communication or tracking for software and/or hardware analysis by analyzer 322. The analyzer 322 in turn is configured for executing a structured algorithm either by digital or analog methods to process light signals received through the optical sensor 320. The light emission system 300 further includes an output device 324 and/or a third party system 326. The output device 324 can include a display, a transmitter, or a signal conditioner for outputting the results of the software/hardware analysis. The third party system 326 can be implemented as any additional devices or control systems that utilize the communication of tracking signal from the LD/LED, provide input, as well as inputting back to the controller 308.

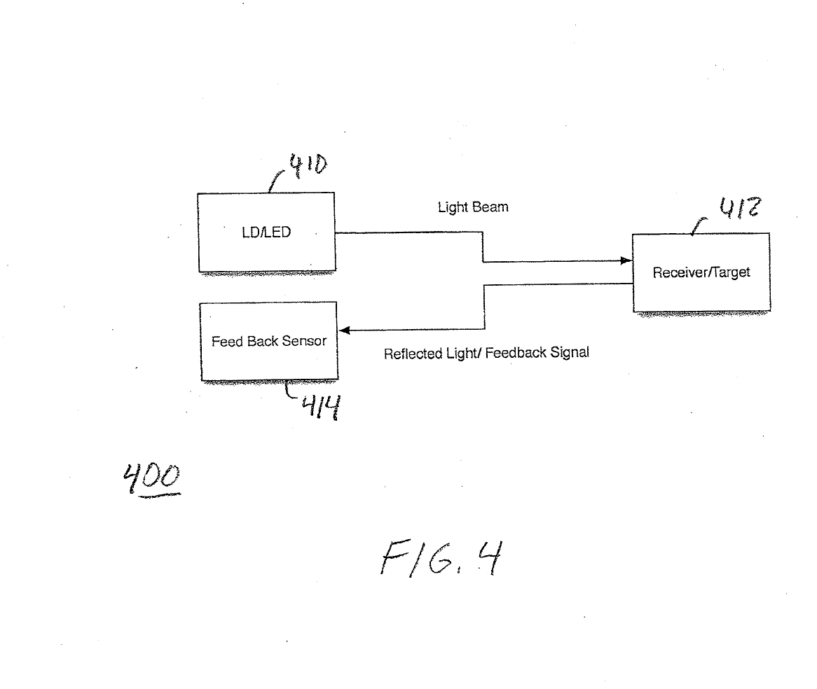

FIG. 4 is a functional block diagram of a light emission and targeting system 400 with feedback sensor. The system 400 includes a light emitter 410. The light emitter 410 is preferably a laser diode having a wavelength centered on the near-UV 405 nm range, but may have a wavelength of between 300 to 490 nm. In some implementations, a diode is used that is rated between 20-600 mW, and where the desired power output is achieved with a combination of current and pulse width modulation (PWM) control. The light emitter 410 produces a light beam that can be directed toward a receiver/target 412. The direction of the light beam from light emitter 410 can be controlled by any type of controller mechanism, such as electronic controls, mechanical controls, and software controls.

Reflected light and/or a feedback signal is directed away from the receiver/target 412 and received by feedback sensor 414 for processing. For example, feedback sensor 414 can receive the reflected light as a second light beam to process the strength and content of the light beam to identify the receiver/target, determine a distance and/or location of the receiver/target, or discern any other useful information about the receiver/target based on the reflected light/feedback signal from the receiver/target.

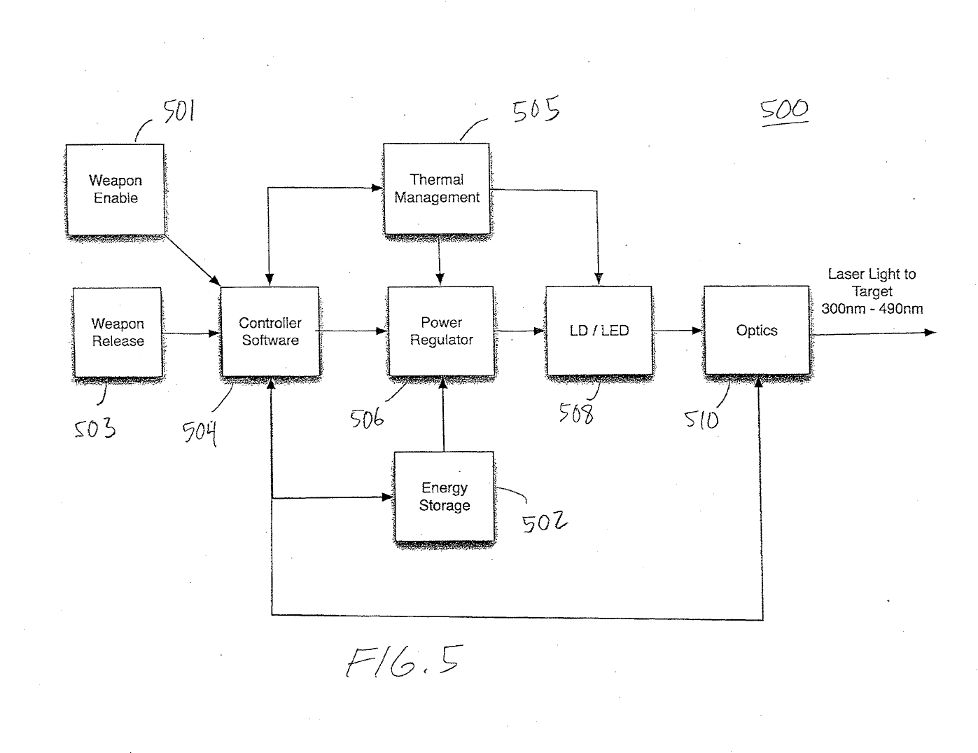

FIG. 5 is a functional block diagram of a light emission system 500 for weapons operation in accordance with an alternative implementation. The light emission system 500 can be used for providing and directing laser light in the range of 300 nm to 490 nm to a target, for guiding a payload from a weapon to the target based on the laser light. The payload can be a bullet, a rocket, a guided missile or any other form of ordinance or payload.

The light emission system 500 includes a weapon enable control 501 that allows a user to enable a weapon, i.e., allows the weapon to fire once all parameters are met, and which activates controller software in a controller 504 of the light emission system 500. The controller 504 also receives signals from a weapon release control 503, is a fire switch for the weapon. The controller 504 also receives control and data signals from other sources, including energy storage 502 and a thermal management module 505. The controller 504 also controls the energy storage 502 and thermal management module 505. The energy storage 502 includes an electrochemical or solid state energy storage device that provides power impulse for firing the laser. The thermal management module 505 includes a cooling unit and controller package that monitor and keeps the controller 504, a power regulator 506, and an LD/LED light source 508 within an optimal or desired thermal range, which can be set by a user either through controller 504 or directly with the thermal management module 505.

The power regulator 506, is substantially as described above, and includes discrete components and/or dedicated integrated circuits to control the voltage and current going to the LED/LD light source 508. The power regulator 506 maintains the proper power to the LD/LED light source 508 over a range of voltages, raising or lowering the input voltage to ensure proper efficient power output.

The controller 504 outputs a signal to control the power regulator 506. The controller 504 can be implemented using embedded micro controllers, computers, specialized application specific integrated circuit (ASIC), complex programmable logic device (CPLD), field programmable gate array (FPGA), or other discrete analog or digital components. Input provided to the controller 504 from the weapon release control 503 turns on power and activates the LD/LED light source 508. The controller 504 preferably controls the power level outputted by the LD/LED light source 508 through pulse width modulation by the power regulator 506.

The LD/LED light source 508 is preferably a laser diode having a wavelength centered on the near-UV 405 nm range, but may have a wavelength of between 300 to 490 nm. In some implementations, a diode is used that is rated between 20-600 mW, and where the desired power output is achieved with a combination of current and pulse width modulation (PWM) control from the power regulator 506. The light emission system 500 further includes optics 510. The optics 510 include one or more glass or acrylic lenses, or crystal lenses, at least one of which can include an optional antireflective coating to maximize optical transfer and culminating of the lens. This lens can be focused to a point or collimated. The focusing process can be done automatically (i.e. electro-mechanically) or manually, or be fixed at manufacturing. The optics 510 focus and direct the laser light from the LD/LED light source 508 to a target, as desired.

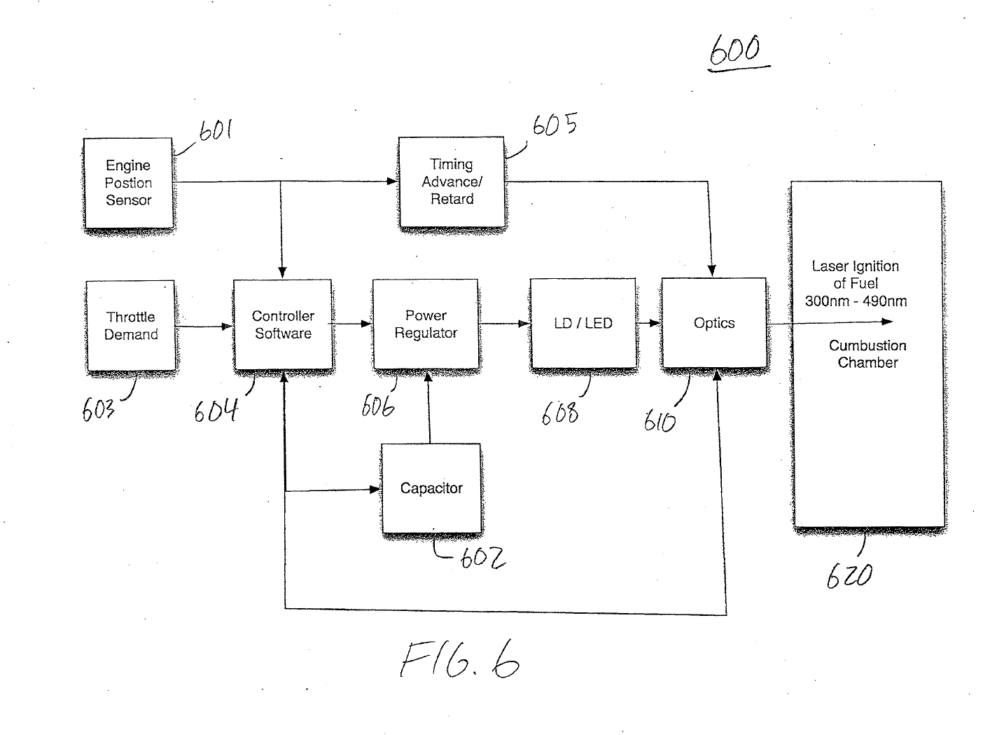

FIG. 6 is a functional block diagram of a light emission system 600 for an ignition system in accordance with an alternative implementation. The light emission system 600 can be used for providing and directing laser light in the range of 300 nm to 490 nm to a combustion chamber 620, to ignite fuel provided therein as part of the ignition system.

The light emission system 600 includes an engine position sensor 601 that communicates a position of an engine shaft (combustion, turbine, etc.) for a controller 604, and for a timing advance/retard module 605 that executes a timing advance/retard algorithm. The controller 604 includes controller software responsive to a throttle demand module 603, which operator/system demand for power or speed derived from fuel that is ignited in measured amounts by the light emission system 600.

The controller 604 also receives and sends control and data signals from/to other modules, including capacitor 602, which provides high-power impulses to a power regulator 606 to feed an LD/LED light source 608 for fuel ignition. The power regulator 606 includes discrete components and/or dedicated integrated circuits to control the voltage and current going to the LED/LD light source 608. The power regulator 606 maintains the proper power to the LD/LED light source 608 over a range of voltages, raising or lowering the input voltage based on energy pulses from the capacitor 602 to ensure proper efficient power output bursts or continual output.

The controller 604 outputs a signal to control the power regulator 606. The controller 604 can be implemented using embedded micro controllers, computers, specialized application specific integrated circuit (ASIC), complex programmable logic device (CPLD), field programmable gate array (FPGA), or other discrete analog or digital components. Input provided to the controller 604 from the weapon release control 603 turns on power and activates the LD/LED light source 608. The controller 604 preferably controls the power level outputted by the LD/LED light source 608 through pulse width modulation by the power regulator 606.

The LD/LED light source 608 is preferably a laser diode having a wavelength centered on the near-UV 405 nm range, but may have a wavelength of between 300 to 490 nm. In some implementations, a diode is used that is rated between 20-600 mW, and where the desired power output is achieved with a combination of current and pulse width modulation (PWM) control from the power regulator 606. The light emission system 600 further includes optics 610. The optics 610 include one or more glass or acrylic lenses, or crystal lenses, at least one of which can include an optional antireflective coating to maximize optical transfer and culminating of the lens. This lens can be focused to a point or collimated. The focusing process can be done automatically (i.e. electro-mechanically) or manually, or be fixed at manufacturing. The optics 610 focus and direct the laser light from the LD/LED light source 608 to a combustion chamber 620.

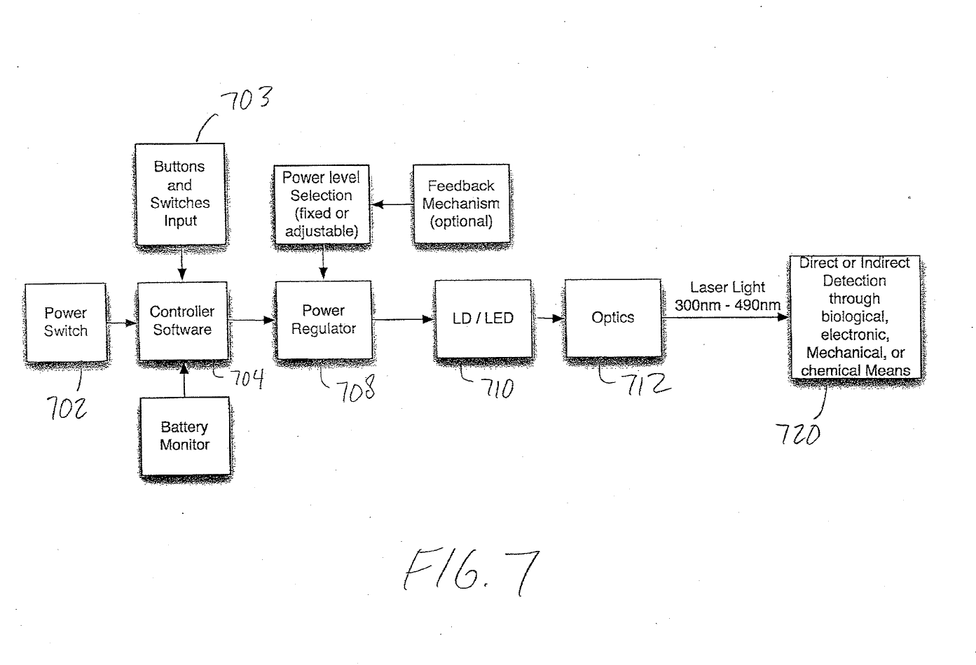

FIG. 7 is a functional block diagram of a light emission system 700 for communications, tracking, guidance and signaling, in accordance with an alternative implementation. Similar to the light emission system 700 shown in FIG. 7, light emission system 700 includes a power switch 702 and input switches/buttons 703 that provide other input signals. The light emission system 700 further includes a controller 704 that also receives input from a power monitor 706, which monitors the power supply (battery or from other sources) and provides input into the controller 704 on the status of the power source. In particular, the power monitor 706 notifies the controller module 704 when the power source is low, i.e. when a battery is almost dead.

The light emission system 700 further includes a power regulator 708, which, as substantially described above, includes discrete components and/or dedicated integrated circuits to control the voltage and current going to the LED/LD light source 710. The power regulator 708 maintains the proper power to the LD/LED light source 710 over a range of voltages, raising or lowering the input voltage to ensure proper efficient power output. A power selector 714 sets the power level of the power regulator 708, and can be implemented as passive or active electronics that alters the settings for the power regulator setting maximum power/current that can be sent to the LED/LD light source 710. The maximum power selector 714 can optionally be controlled through another mechanism manually or automatically which can adjust for distance, ambient light, temperature, or other environmental conditions. The power selector 714 can be controlled or influenced by feedback mechanism 715. The feedback mechanism 715 is configured to implement a power correction method created either by a manually or automatically through optical sensors that adjust power level for position telemetry for communication or alteration in target trajectory.

The controller 704 outputs a signal to control the power regulator 708. The controller 704 can be implemented using embedded micro controllers, computers, specialized application specific integrated circuit (ASIC), complex programmable logic device (CPLD), field programmable gate array (FPGA), or other discrete analog or digital components. Input provided to the controller 704 from the power switch 702 turns on power and activates the unit. Input from input buttons/switches 703 can be used to select modes, and set the power level. The controller 704 can optionally take input from the power monitor 706 and modulate the light beam to indicate the battery level is low. This can optionally go to a separate visual, audible, or mechanical indicator to notify the power state. The controller 704 preferably controls the power level outputted by the LD/LED light source 710 through pulse width modulation. Battery low indictor is current indicated through the periodic lowering/raising of the power level on the laser light, could also be done through blinking.

The LD/LED light source 710 is preferably a laser diode having a wavelength centered on the near-UV 405 nm range, but may have a wavelength of between 300 to 490 nm. In some implementations, a laser or light emitting diode is used that is rated between 20-600 mW, and where the desired power output is achieved with a combination of current and pulse width modulation (PWM) control from the power regulator 708. The light emission system 700 further includes optics 712. The optics 712 include one or more glass or acrylic lenses, at least one of which can include an optional antireflective coating to maximize optical transfer and culminating of the lens. This lens can be focused to a point or collimated. The focusing process can be done automatically (i.e. electro-mechanically) or manually, or be fixed at manufacturing.

The light emission system 700 further includes a detector 720. The detector 720 can be any type of biological, electronic, chemical, mechanical, electro-chemical or biochemical sensing or detecting mechanism. For example, the detector 720 can include a biological organism that can sense the light provided by the light emission system 700. In another implementation, the detector 720 can be an electro-mechanical system such as a photovoltaic cell that detects the light from the LD/LED light source 710, or even a phosphorescent paint that fluoresces at a specific wavelength corresponding to the wavelength of the light provided by light emission system 700.

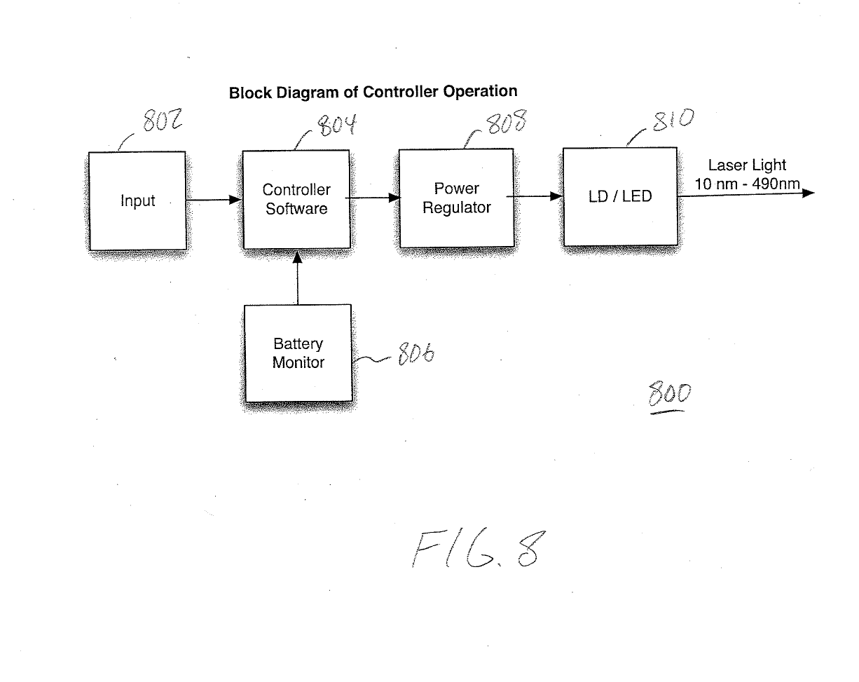

FIG. 8 is a block diagram of a light emission system 800, having an input 802 that provides input signals to a controller 804, which is preferably implemented at least in part in software. The input signals can be from buttons, switches, dials, a keyboard, optical sensors, or other third party systems, computers, or controllers. The controller 804 also receives input from a power monitor 806, which monitors the power supply (battery or from other sources) and provides input into the controller on the status of the power source. In particular, the power monitor 806 notifies the controller module 804 when the power source is low, i.e. when a battery is almost dead.

The light emission system 800 further includes a power regulator 808, which includes discrete components and/or dedicated integrated circuits to control the voltage and current going to the LED/LD. The power regulator 808 maintains the proper power to the LD/LED over a range of voltages, raising or lowering the input voltage to ensure proper efficient power output. In some implementations, the power regulator 808 sets a maximum power level for the LD/LED, and optionally receives input from a controller mechanism which tells it when to power the LD/LED on or off. Preferably, the power regulator 808 can be modulated to obtain different relative power levels, provide different effects and turn on/off the LD. In alternative implementations, the power regulator 808 can have additional mechanisms for lowering and/or raising maximum power to adjust for environmental conditions.

The controller 804 outputs a signal to control the power regulator 808. The controller 804 can be implemented using embedded micro controllers, computers, specialized application specific integrated circuit (ASIC), complex programmable logic device (CPLD), field programmable gate array (FPGA), or other discrete analog or digital components. Input provided to the controller 804 turns on power, activates the unit, selects modes, and sets the power level. The controller 804 can optionally take input from the power monitor 806 and modulate the beam to indicate the battery level is low. This can optionally go to a separate visual, audible, or mechanical indicator to notify the power state. The controller 804 preferably controls the power level outputted by the LD/LED through pulse width modulation. Battery low indictor is current indicated through the periodic lowering/raising of the power level on the laser light, could also be done through blinking.

The light emission system includes a light emitter 810. The light emitter 810 is preferably a laser diode having a wavelength of between 10 nm to 490 nm. In some implementations, a diode is used that is rated between 20-600 mW, and where the desired power output is achieved with a combination of current and pulse width modulation (PWM) control from the power regulator 808.

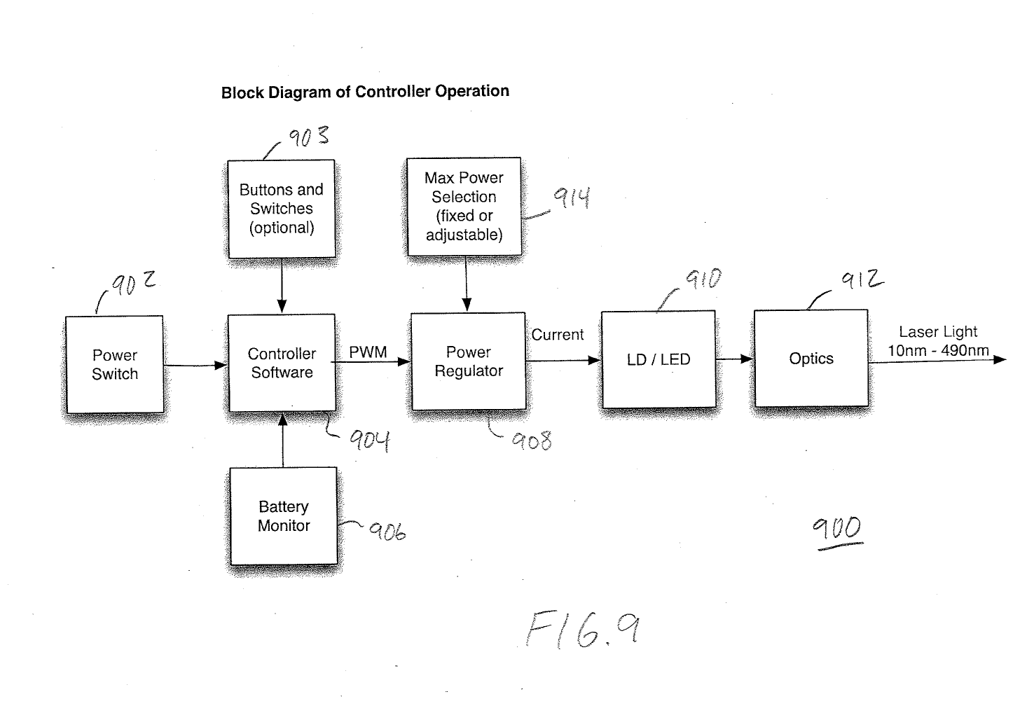

FIG. 9 is a functional block diagram of a light emission system 900 in accordance with an alternative implementation. Similar to the light emission system 100 shown in FIG. 1, light emission system 900 includes a power switch 902 and input switches/buttons 903 that provide other input signals. The light emission system 900 further includes a controller 904 that also receives input from a power monitor 906, which monitors the power supply (battery or from other sources) and provides input into the controller on the status of the power source. In particular, the power monitor 906 notifies the controller module 904 when the power source is low, i.e. when a battery is almost dead.

The light emission system 900 further includes a power regulator 908, which, as substantially described above, includes discrete components and/or dedicated integrated circuits to control the voltage and current going to the LED/LD. The power regulator 908 maintains the proper power to the LD/LED over a range of voltages, raising or lowering the input voltage to ensure proper efficient power output. In some implementations, the power regulator 908 sets a maximum power level for the LD/LED, and optionally receives input from a controller mechanism that can determine when to power the LD/LED on or off. Preferably, the power regulator 908 can be modulated to obtain different relative power levels, provide different effects and turn on/off the LD. In alternative implementations, the power regulator 908 can have additional mechanisms for lowering and/or raising maximum power to adjust for environmental conditions.

The controller 904 outputs a signal to control the power regulator 908. The controller 904 can be implemented using embedded micro controllers, computers, specialized application specific integrated circuit (ASIC), complex programmable logic device (CPLD), field programmable gate array (FPGA), or other discrete analog or digital components. Input provided to the controller 904 from the power switch 902 turns on power and activates the unit. Input from input buttons/switches 903 can be used to select modes, and set the power level. The controller 904 can optionally take input from the power monitor 906 and modulate the light beam to indicate the battery level is low. This can optionally go to a separate visual, audible, or mechanical indicator to notify the power state. The controller 904 preferably controls the power level outputted by the LD/LED through pulse width modulation. Battery low indictor is current indicated through the periodic lowering/raising of the power level on the laser light, could also be done through blinking.

The light emission system includes a light emitter 910. The light emitter 910 is preferably a laser diode having a wavelength of between 10 to 490 nm. In some implementations, a diode is used that is rated between 20-600 mW, and where the desired power output is achieved with a combination of current and pulse width modulation (PWM) control from the power regulator 908. The light emission system 900 further includes optics 912. The optics 912 include one or more glass or acrylic lenses, at least one of which can include an optional antireflective coating to maximize optical transfer and culminating of the lens. This lens can be focused to a point or collimated. The focusing process can be done automatically (i.e. electro-mechanically) or manually, or be fixed at manufacturing.

The light emission system 900 further includes a maximum power selector 914 implemented as passive or active electronics that alters the settings for the power regulator setting maximum power/current that can be sent to the LED/LD. The maximum power selector 914 can optionally be controlled through another mechanism manually or automatically which can adjust for distance, ambient light, temperature, or other environmental conditions.

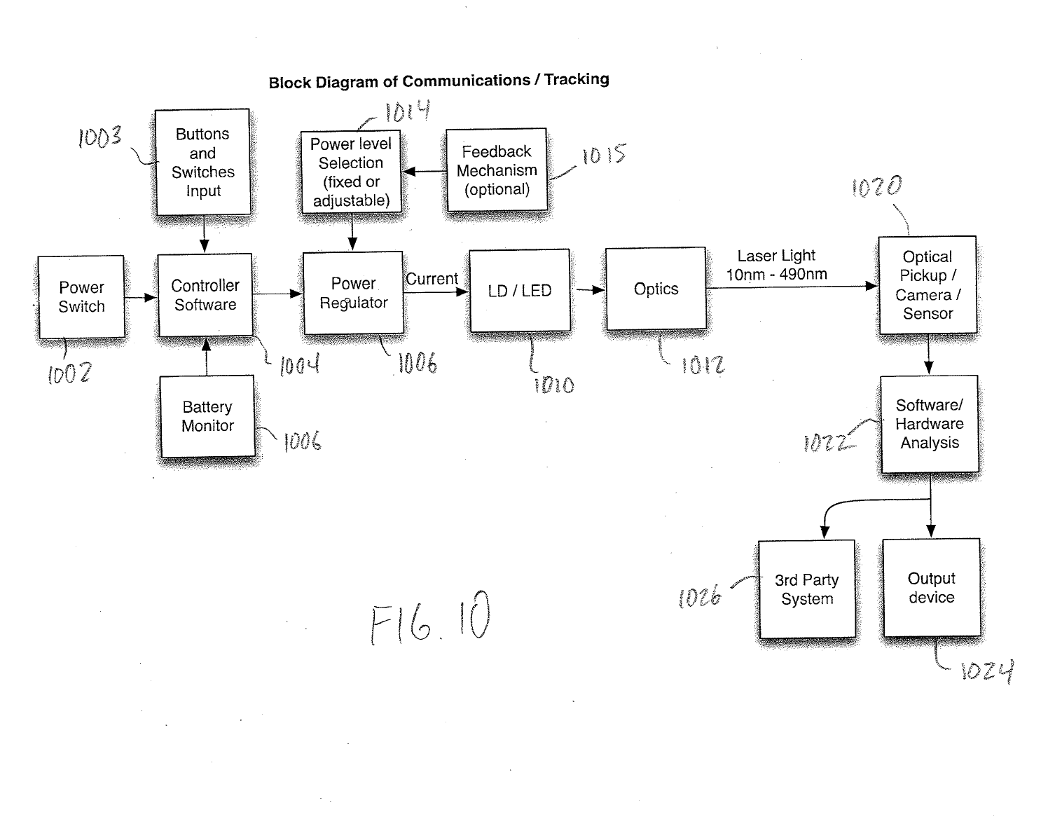

FIG. 10 is a functional block diagram of a light emission system 1000 in accordance with yet another alternative implementation, and suitable for use in communications and tracking. The light emission system 1000 includes a power switch 1002 and input switches/buttons 1003 that provide other input signals. The light emission system 1000 further includes a controller 1004 that also receives input from a power monitor 1006, which monitors the power supply (battery or from other sources) and provides input into the controller on the status of the power source. In particular, the power monitor 1006 notifies the controller module 1004 when the power source is low, i.e. when a battery is almost dead.

The light emission system 1000 further includes a power regulator 1008, which, as substantially described above, includes discrete components and/or dedicated integrated circuits to control the voltage and current going to the LED/LD. The power regulator 1008 maintains the proper power to the LD/LED over a range of voltages, raising or lowering the input voltage to ensure proper efficient power output. A power selector 1014 sets the power level of the power regulator 1008, and can be implemented as passive or active electronics that alters the settings for the power regulator setting maximum power/current that can be sent to the LED/LD. The maximum power selector 1014 can optionally be controlled through another mechanism manually or automatically which can adjust for distance, ambient light, temperature, or other environmental conditions. The power selector 1014 can be controlled or influenced by feedback mechanism 1015. The feedback mechanism 1015 is configured to implement a power correction method created either by a manually or automatically through optical sensors that adjust power level for position telemetry for communication or alteration in target trajectory.

The controller 1004 outputs a signal to control the power regulator 1008. The controller 1004 can be implemented using embedded micro controllers, computers, specialized application specific integrated circuit (ASIC), complex programmable logic device (CPLD), field programmable gate array (FPGA), or other discrete analog or digital components. Input provided to the controller 1004 from the power switch 1002 turns on power and activates the unit. Input from input buttons/switches 10010 can be used to select modes, and set the power level. The controller 1004 can optionally take input from the power monitor 1006 and modulate the light beam to indicate the battery level is low. This can optionally go to a separate visual, audible, or mechanical indicator to notify the power state. The controller 1004 preferably controls the power level outputted by the LD/LED through pulse width modulation. Battery low indictor is current indicated through the periodic lowering/raising of the power level on the laser light, could also be done through blinking.

The light emission system 1000 includes a light emitter 1010. The light emitter 1010 is preferably a laser diode having a wavelength between 10 and 490 nm. In some implementations, a diode is used that is rated between 20-600 mW, and where the desired power output is achieved with a combination of current and pulse width modulation (PWM) control from the power regulator 1008. The light emission system 1000 further includes optics 1012. The optics 1012 include one or more glass or acrylic lenses, at least one of which can include an optional antireflective coating to maximize optical transfer and culminating of the lens. This lens can be focused to a point or collimated. The focusing process can be done automatically (i.e. electro-mechanically) or manually, or be fixed at manufacturing.

The light emission system 1000 further includes optical sensor 1020. The optical sensor 1020 can be any type of electronic optical pickup, camera or sensor, and is implemented as a receiving device as either a photo or optical sensor that can sense LD/LED transmission or light emission for communication or tracking for software and/or hardware analysis by analyzer 1022. The analyzer 1022 in turn is configured for executing a structured algorithm either by digital or analog methods to process light signals received through the optical sensor 1020. The light emission system 1000 further includes an output device 1024 and/or a third party system 1026. The output device 1024 can include a display, a transmitter, or a signal conditioner for outputting the results of the software/hardware analysis. The third party system 1026 can be implemented as any additional devices or control systems that utilize the communication of tracking signal from the LD/LED, provide input, as well as inputting back to the controller 1008.

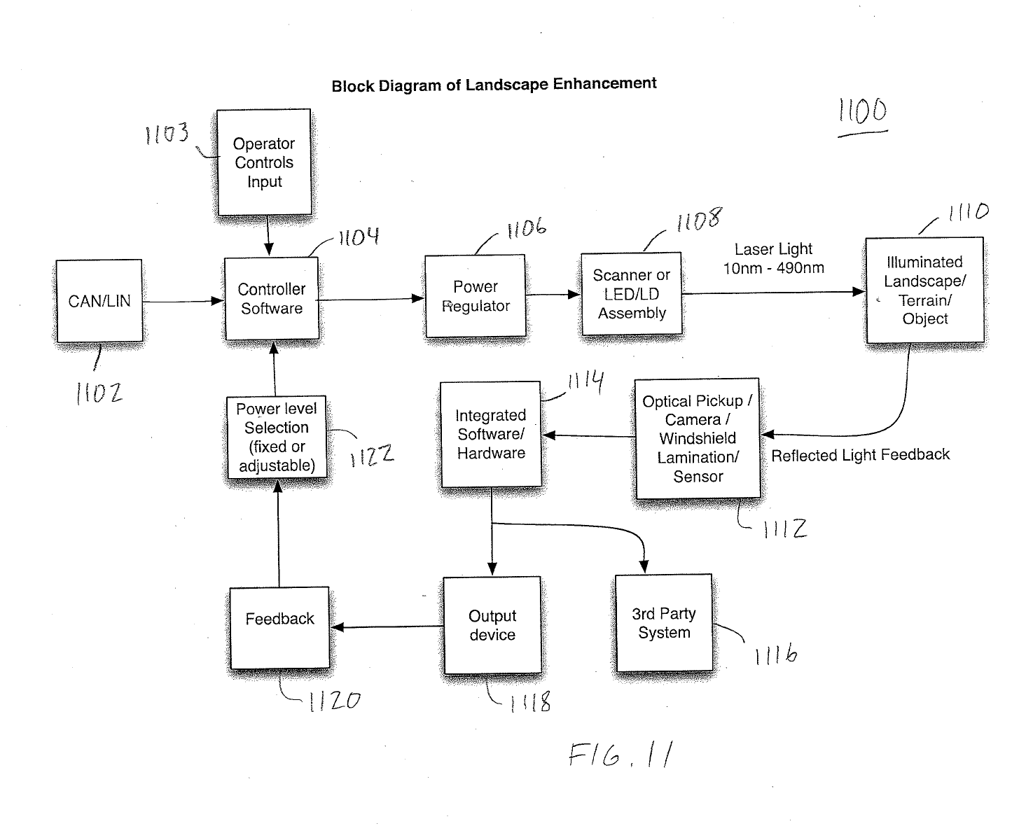

FIG. 11 is a block diagram of a light emission system 1100, configured for landscape enhancement, such as for lightening dark landscape areas or features, lane tracking for automobiles, enhanced digital mapping, collision avoidance systems and parking sensors. The light emission system 1100 includes an input 1102 that provides input signals to a controller 1104, which is preferably implemented at least in part in software. The input signals can be from a Controller Area Network (CAN) and/or a Local Interconnect Network (LIN) message-generating system. The controller 1104 also receives input from operator controls 1103, such as buttons, switches, knobs, or touch screen displays, which produce electronic input control signals. The controller 1104 also receives power level selection input signals from a power level selector 1122, which monitors the power supply (battery or from other sources) and provides input into the controller 1104 on the status of the power source. In particular, the power level selector 1122 notifies the controller module 1104 when the power source is low, i.e. when a battery is almost dead, or controls a power level to be fixed or dynamically adjusted.

The light emission system 1100 further includes a power regulator 1106, which includes discrete components and/or dedicated integrated circuits to control the voltage and current going to a scanner or LED/LD assembly 1108. The power regulator 1106 maintains the proper power to the LED/LD assembly 1108 over a range of voltages, raising or lowering the input voltage to ensure proper efficient power output. In some implementations, the power regulator 1106 sets a maximum power level for the LED/LD assembly 1108. Preferably, the power regulator 1106 can be modulated to obtain different relative power levels, provide different effects and turn on/off the LED/LD assembly 1108. In alternative implementations, the power regulator 108 can have additional mechanisms for lowering and/or raising maximum power to adjust for environmental conditions. The controller 1104 outputs a signal to control the power regulator 1106. The controller 1104 can be implemented using embedded micro controllers, computers, specialized application specific integrated circuit (ASIC), complex programmable logic device (CPLD), field programmable gate array (FPGA), or other discrete analog or digital components.

The power regulator 1106 causes the LED/LD assembly 1108 to illuminate a landscape 1110, terrain or object therein. The LED/LD assembly 1108 may have a wavelength of between 10 to 490 nm. In some implementations of an LD, a diode is used that is rated between 10-600 mW, and where the desired power output is achieved with a combination of current and pulse width modulation (PWM) control from the power regulator 1108. Reflected light from the landscape 1110 is received, sensed or otherwise picked up by optical pickup 1112. The optical pickup 1112 can be a camera, sensor, or may be a material embedded or laminated into a pickup surface, such as the windshield of an automobile.

The reflected light picked up by optical pickup 1112 is sent, either in received form or processed, to integrated software and hardware 1114, which processes the reflected light to send or transmit the processed signals to a third party system 1116 or an output device 1118, such as a display, monitor, head-up display (HUD), portable computer, or the like. In the case of an output device 1118, the processed signals can be displayed or further transferred to a feedback module 1120, which can provide input and control signals to the power level selector 1122 to modulate the power level of the light emission system 1100.

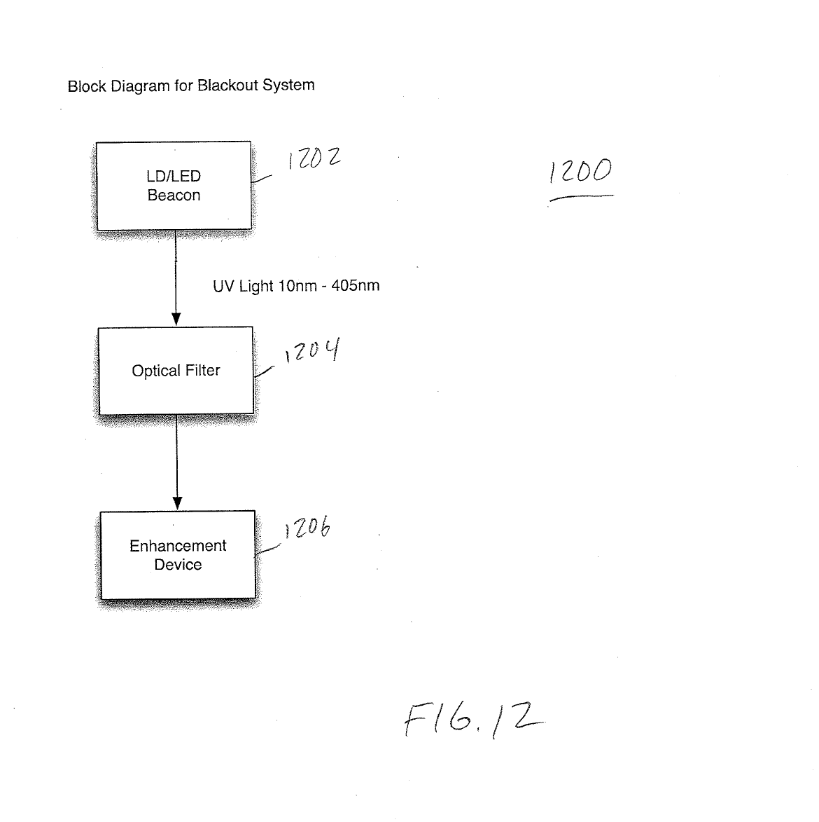

FIG. 12 is a functional block diagram of a blackout system 1200, i.e. in a scenario when the landscape is devoid of light, or is needed to be devoid of light or visible light emitters. The blackout system 1200 includes an LD/LED beacon 1202 that provides light at a wavelength of between 10 and 405 nm. The blackout system further includes optical filter 1204, and an enhancement device 1206.

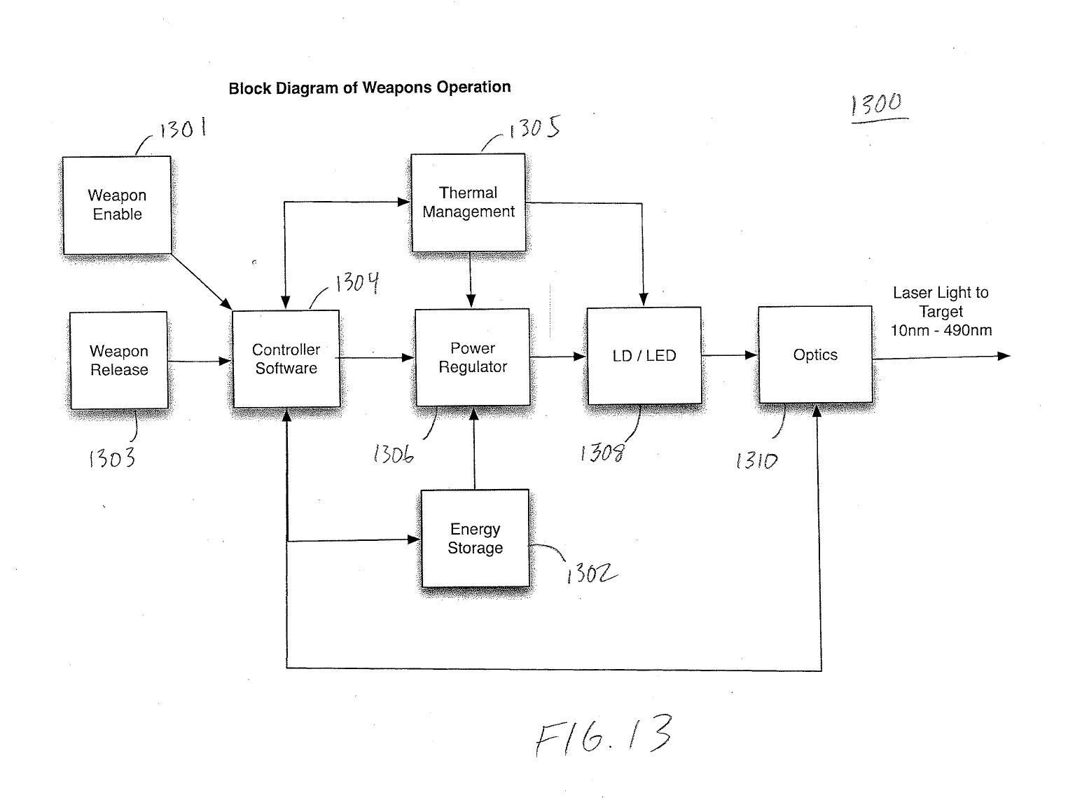

FIG. 13 is a functional block diagram of a light emission system 1300 for weapons operation in accordance with an alternative implementation. The light emission system 1300 can be used for providing and directing laser light in the range of 300 nm to 490 nm to a target, for guiding a payload from a weapon to the target based on the laser light. The payload can be a bullet, a rocket, a guided missile or any other form of ordinance or payload.

The light emission system 1300 includes a weapon enable control 1301 that allows a user to enable a weapon, i.e., allows the weapon to fire once all parameters are met, and which activates controller software in a controller 1304 of the light emission system 1300. The controller 1304 also receives signals from a weapon release control 1303, is a fire switch for the weapon. The controller 1304 also receives control and data signals from other sources, including energy storage 1302 and a thermal management module 1305. The controller 1304 also controls the energy storage 1302 and thermal management module 1305. The energy storage 1302 includes an electrochemical or solid state energy storage device that provides power impulse for firing the laser. The thermal management module 1305 includes a cooling unit and controller package that monitor and keeps the controller 1304, a power regulator 1306, and an LD/LED light source 1308 within an optimal or desired thermal range, which can be set by a user either through controller 1304 or directly with the thermal management module 1305.

The power regulator 1306, is substantially as described above, and includes discrete components and/or dedicated integrated circuits to control the voltage and current going to the LED/LD light source 1308. The power regulator 1306 maintains the proper power to the LD/LED light source 1308 over a range of voltages, raising or lowering the input voltage to ensure proper efficient power output.

The controller 1304 outputs a signal to control the power regulator 1306. The controller 1304 can be implemented using embedded micro controllers, computers, specialized application specific integrated circuit (ASIC), complex programmable logic device (CPLD), field programmable gate array (FPGA), or other discrete analog or digital components. Input provided to the controller 1304 from the weapon release control 1303 turns on power and activates the LD/LED light source 1308. The controller 1304 preferably controls the power level outputted by the LD/LED light source 1308 through pulse width modulation by the power regulator 1306.

The LD/LED light source 1308 is preferably a laser diode having a wavelength of between 10 to 490 nm. In some implementations, a diode is used that is rated between 20-600 mW, and where the desired power output is achieved with a combination of current and pulse width modulation (PWM) control from the power regulator 1306. The light emission system 1300 further includes optics 1310. The optics 1310 include one or more glass or acrylic lenses, or crystal lenses, at least one of which can include an optional antireflective coating to maximize optical transfer and culminating of the lens. This lens can be focused to a point or collimated. The focusing process can be done automatically (i.e. electro-mechanically) or manually, or be fixed at manufacturing. The optics 1310 focus and direct the laser light from the LD/LED light source 1308 to a target, as desired.

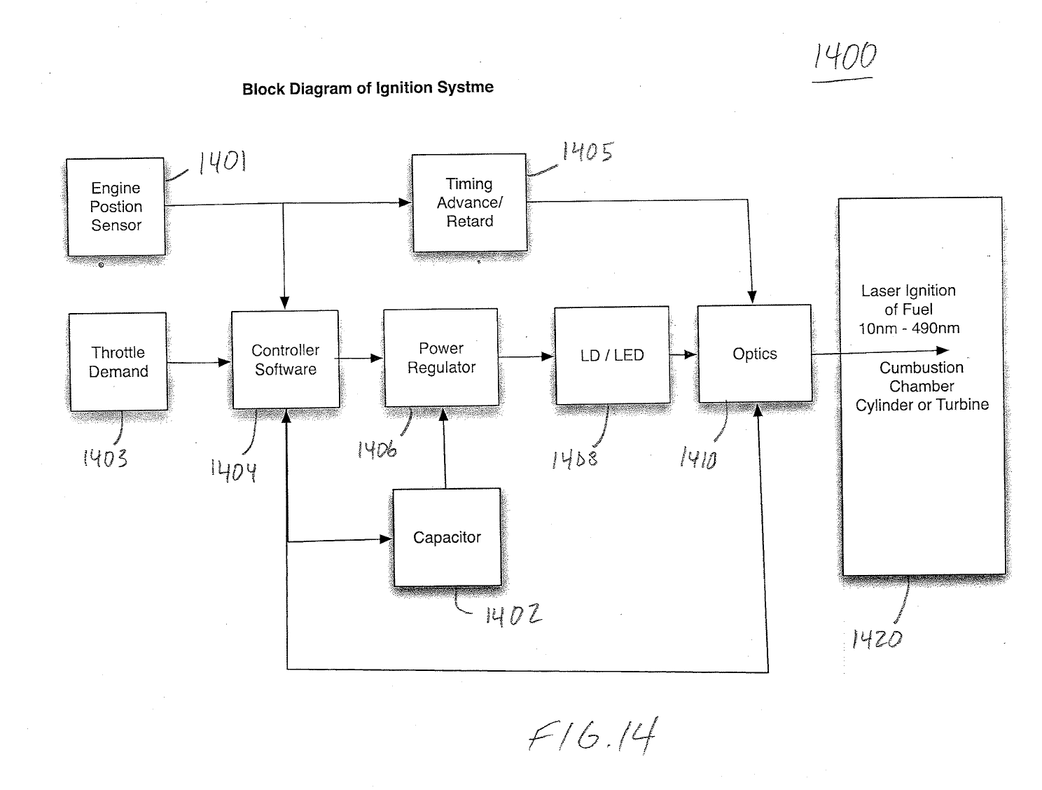

FIG. 14 is a functional block diagram of a light emission system 1400 for an ignition system in accordance with an alternative implementation. The light emission system 1400 can be used for providing and directing laser light in the range of 300 nm to 490 nm to a combustion chamber 1420, to ignite fuel provided therein as part of the ignition system.

The light emission system 1400 includes an engine position sensor 1401 that communicates a position of an engine shaft (combustion, turbine, etc.) for a controller 1404, and for a timing advance/retard module 1405 that executes a timing advance/retard algorithm. The controller 1404 includes controller software responsive to a throttle demand module 1403, which operator/system demand for power or speed derived from fuel that is ignited in measured amounts by the light emission system 1400.

The controller 1404 also receives and sends control and data signals from/to other modules, including capacitor 1402, which provides high-power impulses to a power regulator 1406 to feed an LD/LED light source 1408 for fuel ignition. The power regulator 1406 includes discrete components and/or dedicated integrated circuits to control the voltage and current going to the LED/LD light source 1408. The power regulator 1406 maintains the proper power to the LD/LED light source 1408 over a range of voltages, raising or lowering the input voltage based on energy pulses from the capacitor 1402 to ensure proper efficient power output bursts or continual output.

The controller 1404 outputs a signal to control the power regulator 1406. The controller 1404 can be implemented using embedded micro controllers, computers, specialized application specific integrated circuit (ASIC), complex programmable logic device (CPLD), field programmable gate array (FPGA), or other discrete analog or digital components. Input provided to the controller 1404 from the weapon release control 1403 turns on power and activates the LD/LED light source 1408. The controller 1404 preferably controls the power level outputted by the LD/LED light source 1408 through pulse width modulation by the power regulator 1406.

The LD/LED light source 1408 is preferably a laser diode having a wavelength of between 10 to 490 nm. In some implementations, a diode is used that is rated between 20-600 mW, and where the desired power output is achieved with a combination of current and pulse width modulation (PWM) control from the power regulator 1406. The light emission system 1400 further includes optics 1410. The optics 1410 include one or more glass or acrylic lenses, or crystal lenses, at least one of which can include an optional antireflective coating to maximize optical transfer and culminating of the lens. This lens can be focused to a point or collimated. The focusing process can be done automatically (i.e. electro-mechanically) or manually, or be fixed at manufacturing. The optics 1410 focus and direct the laser light from the LD/LED light source 1408 to a combustion chamber 1420.

In any of the implementations described above, all of the components can be formed into a single package or housing. Although a few embodiments have been described in detail above, other modifications are possible. For example, any of the diodes used for providing light in the range of 10 nm to 490 nm can be rated between 600 mW and 10 W or more. Further, various other materials can be used for the optics to control the direction of the light source, such as crystals, rubies or other precious stones. Other embodiments may be within the scope of the following claims.

1. A method comprising:
generating light from a diode, the light being generated at a wavelength between 10 nm to 490 nm; and
forming the light to a directional light beam; and
controlling to the directional light beam to direct the directional light beam at a target.

2. A system comprising:
a light generator that generates light from a diode at a wavelength between 10 nm and 490 nm;
a light beam forming subsystem that forms the light to a directional light beam; and
a controller that controls and directs the directional light beam to a target.

3. A light emission system comprising:
a housing having at least one outlet aperture, the housing containing:
a diode that emits light at a wavelength between 10 nm and 490 nm;
a power regulator that provides power to the diode at a specific power level;
a controller responsive to input signals for controlling the power regulator to generate the power at the specific power level; and
optics for forming and directing the light from the diode into a directional light beam that is output through the outlet aperture.

4. The light emission system in accordance with claim 3, wherein the housing further contains an energy source for providing electrical energy to the power regulator.

5. The light emission system in accordance with claim 3, wherein the housing further includes an input control for providing the input signals to the controller.

6. The light emission system in accordance with claim 3, wherein the optics includes one or more lenses configured to focus the light from the diode into the directional light beam.

7. The light emission system in accordance with claim 5, wherein housing is coupled to a weapon that fires a ballistic payload toward a terminus of the directional light beam, and wherein the input control includes:
a weapon enable module that enables the weapon to fire the ballistic payload; and
a weapon release module that directs the controller to generate the light as a pulse from the diode.

8. The light emission system in accordance with claim 5, wherein housing is coupled to a combustion chamber containing fuel, and wherein the input control includes:
a throttle demand switch that provides an input signal representing a measured amount of light to be provided by the diode.

9. The light emission system in accordance with claim 3, further comprising a detector for detecting the directional light beam at a position distal from the housing.

10. The light emission system in accordance with claim 3, further comprising a sensor for sensing a presence of the directional light beam at a target distal from the housing.

11. The light emission system in accordance with claim 10, wherein the sensor communicates the sensing to the controller.
